(19) United States
(12) Patent Application Publication
(10) Pub. No.: US 2022/0312165 A1
(43) Pub. Date: Sep. 29, 2022

(54) SYSTEM AND METHOD FOR CREATING A THREE-PARTY COMMUNICATION PLATFORM TO DELIVER SERVICES

(71) Applicant: ASHISH GAJANAN ASGEKAR, BENGALURU (IN)

(72) Inventor: ASHISH GAJANAN ASGEKAR, BENGALURU (IN)

(21) Appl. No.: 17/618,281

(22) PCT Filed: Jun. 21, 2020
(86) PCT No.: PCT/IB2020/055838

§ 371 Date: Dec. 10, 2021

(30) Foreign Application Priority Data
Jun. 21, 2019 (IN) 201941024822

(51) Int. Cl. H04W 4/80; H04W 4/021; H04L 9/00; H04L 9/14; H04L 9/08

(52) U.S. Cl. CPC H04W 4/80; H04W 4/021; H04L 9/50; H04L 9/14; H04L 9/0825; H04L 2209/80; H04L 2209/56

(57) ABSTRACT

System and method for creating a third-party communication platform to deliver services are disclosed. The system includes one or more processors. The processor includes an input module configured to receive a plurality of identity details associated with three parties, an identity verification module configured to verify the plurality of identity details of the first primary party, the second primary party and the secondary party using a blockchain-based storage subsystem, a service delivery module configured to define a set of transactions between the first primary party and the second primary party via a secondary party. The service delivery module is also configured to form a three-party network among the three parties to complete the set of transactions, prior to commencing at least one of a future transaction between the same parties, and record transactions using block-party and the second primary party via a secondary party chain platform for later perusal by any party.

This International Application claims priority from a provisional patent application filed in India having Patent Application No. 201941024822, filed on Jun. 21, 2019 and titled “SYSTEM AND METHOD FOR THREE-PARTY COMMUNICATION TO DELIVER A SERVICE”.

### FIELD OF INVENTION

Embodiments of a present disclosure relates to three-party network, and more particularly, to a system and a method for creating a three-party communication platform to deliver services in person.

### BACKGROUND

With the rapid development of communication technology and further fusion of the communication technology with the internet technology, the popularity rates of mobile services and mobile internet technology growing leaps and bounds. The users of service industry often desire access to a plurality of services and different service providers. The service providers provide the plurality of services to the user manually. However, some of the service delivery platforms are not transparent in their operations and do not provide transaction history to the users. Considering an example where a guest is arriving in a new country and a hotel sends a driver for pick up from airport to hotel. Mostly the driver, though sometimes also the Guest, would wait over a long duration in the lobby of the airport for the other party to arrive. However, such situation may lead to stressful condition for both driver and the guest.

Furthermore, the driver must attract the attention of the guest using a placard with guest's name or the hotel logo. However, the poorly designed name placards, displayed in erratic manner, in a crowded place makes it difficult for the guest to search the driver.

Moreover, in some cases the guest does not have a local phone or data connection which may making it very hard to connect to access information and communicate with driver or the hotel. Moreover, in some cases the guest may not want to show their name in public view for privacy and safety reasons. Such situation may lead to safety issue of the guest and delay in providing the service to the guest.

Hence there is a need for an improved system and method for creating a three-party communication platform to seamlessly deliver services to address the aforementioned issues.

### BRIEF DESCRIPTION

In accordance with one embodiment of the disclosure, a system to create a three-party communication platform to deliver services is disclosed. The system includes one or more processors. The one or more processors includes an input module configured to receive a plurality of identity details associated with three parties. The three parties include a first primary party, a second primary party and a secondary party. The processor includes an identity verification module configured to verify the plurality of identity details of the first primary party, the second primary party and the secondary party using a blockchain-based storage subsystem. The processor also includes a service delivery module configured to define a set of transactions between the first primary party and the second primary party via a secondary party, wherein the set of transactions are corresponding to the plurality of services. The service delivery module is also configured to form a three-party network among the three parties to complete the set of transactions, prior to commencing at least one of a future transaction between the same parties upon tracking a location of each of the three parties and creating a geofence of a pre-defined location among the three parties. The service delivery module is also configured to create a seamless communication channel within an established geofenced pre-defined location to enable the three-parties to communicate among each other in real time.

In accordance with an embodiment of the present disclosure, a method for creating a three-party communication platform to deliver a plurality of services is disclosed. The method includes receiving a plurality of identity details associated with three parties, wherein the three parties comprises a first primary party, a second primary party and a secondary party. The method also includes verifying the plurality of identity details of the first primary party, the second primary party and the secondary party using a block-chain based P2P network of computers. The method also includes defining a set of transactions between the first primary party and the second primary party via a secondary party, wherein the set of transactions are corresponding to the plurality of services. The method also includes forming a three-party network among the three parties to complete the set of transactions, prior to commencing at least one of a future transactions between the same parties. The method also includes creating a seamless communication channel within an established geofenced pre-defined location to enable the three-parties to communicate among each other in real time.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system to create a three-party communication platform to deliver a plurality of services in accordance with an embodiment of the present disclosure;

FIG. 2 is a block diagram representation of an exemplary embodiment of the system used in a transport service to a hotel of FIG. 1 in accordance with an embodiment of the present disclosure;

FIG. 3 is a block diagram representation of a processing subsystem located on a local server or on a remote server in accordance with an embodiment of the present disclosure; and

FIG. 4 is a flow chart representing steps involved in a method for creating a three-party communication platform to deliver a plurality of services in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for creating a three-party communication platform to deliver a plurality of services.

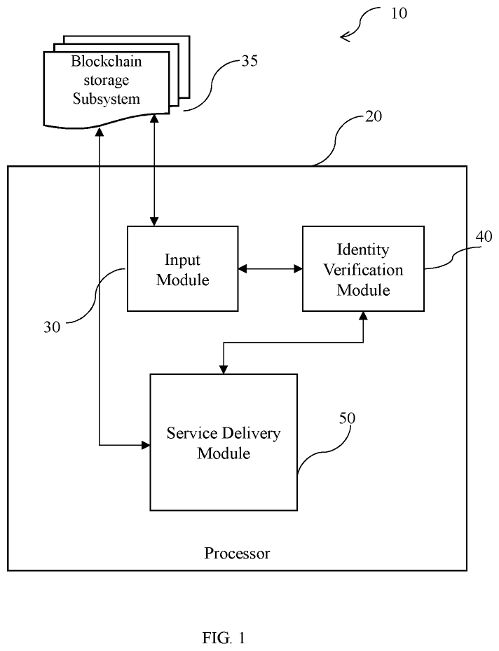

FIG. 1 is a block diagram representing a system (10) to create a three-party communication platform to deliver a plurality of services in accordance with an embodiment of the present disclosure. The system (10) includes one or more processors (20). The one or more processors (20) includes an input module (30) configured to receive a plurality of identity details associated with at least three parties. The three parties include a first primary party, a second primary party and a secondary party. In one embodiment, identity data uses a block-chain based P2P network of computers or blockchain storage subsystem (35) to store temper-proof identity (ID) of the three parties. The temper-proof ID may include at least one of a government ID, a picture, phone number, social media profile and the like. In such embodiment, the plurality of identity details may include identity data and transaction history. In one embodiment, the transaction history includes a plurality of service details, a plurality of payment details and a detail of change in identity data, or the like. Further, in one exemplary embodiment, the first primary party may deliver one of the plurality of services to the second primary party via the secondary party, wherein the delivery of the service may happen in person. In some embodiments, the transaction may be associated to pickup and drop services, delivery service, or the like from one destination to another. The present invention relies on standard blockchain protocol, invoking public and private keys of each party in the 3-party network, confirming identities via P2P block-chain network of computers.

The processor (20) further includes an identity verification module (40) operatively coupled to the input module (30). The identity verification module (40) is configured to verify the plurality of identity details of the first primary party, the second primary party and the secondary party using a block-chain based P2P network of computers (35). In one embodiment, the plurality of identity details may be linked to blockchain ID for each of the three-parties. In an embodiment, the verification module is configured to receive an encrusted private key from one or more users, where the private key is mapped with public key of the corresponding party as per Block-chain protocol. The identity verification module verifies the user once the pair of private and public key is authenticated. In such embodiment, the plurality of identity details may include a government—sponsored unique ID associated with the corresponding three-parties. In some embodiments, the processor (20) may further include an identity generation module operatively coupled to the input module (30). The identity generation module may be configured to generate a unique identity for each of the first primary party, the second primary party and the secondary party using blockchain platform.

The processor (20) also includes a service delivery module (50) operatively coupled to the identity verification module (40) and block-chain based P2P network of computers. A user may demand earlier history of transactions and therefore the service delivery module is enabled to connect to the block chain system to retrieve those transactions, while also recording this service-request on the block-chain subsystem. In such an embodiment, the service delivery module (50) also interacts with P2P blockchain network to record the transaction details of each service provided and any associated payments and the transaction recording again uses block-chain protocol. The service delivery module (50) is configured to define a set of transactions between the first primary party and the second primary party via a secondary party, wherein the set of transactions are corresponding to the plurality of services. In one embodiment, the plurality of services may include pick-up and drop services, delivery service, or the like from one destination to another. The service delivery module (50) is also configured to establish a three-party network among the three parties and a local two party network, using a local Wi-Fi, Hotspot or Bluetooth, between the second primary party and the secondary party to complete the set of transactions, prior to commencing at least one of a future transaction between the same parties. In one embodiment, the three-party network may be formed to complete the set of transactions at a first-time interval, before commencing any future transactions between the same parties. Each party from the three parties may form a new three-party network at a second time interval with other one or more parties after breaking the existing three-party network between previous one or more parties which leads to formation of mesh of three-party networks over the passage of time.

In one exemplary embodiment, the one or more processors (20) may include a location tracking module operatively coupled to the input module (30). The location tracking module may be configured to receive a real-time location of at least one of the first primary party, the second primary party and the secondary party tracked using a tracking enabled smart device.

In some embodiments, a transaction location is agreed tentatively by the first primary party and the second primary party and is stored in an electronic device of each party via an interface. In such embodiment, the transaction location may be altered by each party if the meeting is delayed due to external reasons such as weather, traffic or the like and may share the updated meeting time or any change in the transaction location. In a specific embodiment, when each the second primary party and the secondary party arrives near a predefined location such as a home, an airport, or the like, the interface may utilise the locally available wireless networks such as Wi-Fi or networking Hotspot if present. In a further embodiment, the interface, in absence of WiFi, creates Bluetooth based network to establish a link between the electronic devices of the second primary party and the secondary party. The present invention takes care of scenarios where the second primary party does not have a GSM network in his/her smart device and unable to use the GPRS or Cellular data (2G, 3G, 4G or 5G). In such embodiment, the network's service set identifiers (SSIDs) are used and hence third parties can not join the network and thereby preventing unauthorised access or hacking.

In another embodiment, when each party arrives near a predefined location, the interface starts a Hotspot on the electronic device of the secondary party may automatically be updated with a predetermined password. Such hotspot carries a range of up to 20 meters, sufficient to cover most locations. The mobile phone of the first primary party or the second primary party, in case of lacking internet connectivity, can automatically find and connect to the Hotspot on the electronic device of Secondary party using a pre-determined password. The smart device of the second primary party is configured to generate an alphanumeric password for the Hotspot or Bluetooth network so created and transmit the same to the device associated with the secondary party, thereby enabling a password-based connection between the two smart devices without any human intervention. At this point the first primary party or the second primary party receives a message that the secondary party is waiting, and its network is available.

In one exemplary embodiment, the relative locations corresponding to each party may be shared using geolocation tracking and guiding them turn by turn to walk towards each other which may be tracked using the tracking enabled smart device such as a GPS tracker. In such embodiment, the first primary party the second primary party and the secondary party may communicate with each other via the interface of the device. The plurality of details of the secondary party at this point then shared and the second primary party may look at the plurality of details such as photo, name and a few other relevant identity details, stored in the block-chain based P2P network of computers, of the secondary party. If agreeable, the second primary party can then “Accept” to connect with the secondary party for delivery of one of the plurality of services.

In some embodiments, the secondary party may also see the relevant personal details of the second primary party, which enables secondary party to meet the second primary party in person. The first primary party receives a notification that the second primary party and the secondary party have initiated the transactions. Their locations are then shared with the first primary party along with other transaction details. In one exemplary embodiment, the processor may include an interaction module which may be operatively coupled the service delivery module. The interaction module may be configured to assist the three parties to interact therebetween using audio, image, visual, textual means or the like.

The service delivery module (50) is also configured to create a geofence at a pre-defined location via smart devices associated with one of the second primary party and the secondary party among the three parties. In one exemplary embodiment, the service delivery module (50) may be configured to provide one or more actions upon creating the geofence at the pre-defined location, wherein the one or more actions comprises one of fetching the passwords for available Wi-Fi network at the pre-defined location, attempt to connect to one or more devices using the available network at the pre-defined location, creation of Hotspot using a network, creation of a Bluetooth based network to establish a link between the electronic devices of the second primary party and the secondary party, sending an alert of arrival to the second primary party, or the combination thereof.

Furthermore, the service delivery module (50) is configured to create a seamless communication channel within an established geofenced pre-defined location to enable the three-parties to communicate among each other in real time. The smart devices associated with the second primary party the secondary party being configured to create geofenced perimeter in real geographic location. Further, the smart device associated with the second primary party the secondary party are configured to initiate a plurality of actions based on the geofenced pre-defined location once the smart device enters a set location, including but not limited to, fetching the passwords for available Wi-Fi network at airport, attempt to connect devices using the available network or creation of Hotspot using network and connecting the other device, sending alert of arrival to second primary user, and the like. In one embodiment, the seamless communication channel may include one of Bluetooth channel, a wireless fidelity channel, a hotspot channel, or the like within the geofenced pre-defined location. The system is designed in a smart manner to identify the available networking option available and then using the most suitable networking option to establish the network. Each of the Bluetooth channel, a wireless fidelity channel, a hotspot channel is assigned priority or preference ranking over each other in order to enable a smart selection.
The service delivery module (50) is configured to enable payments for services rendered via a banking network or a crypto-currency using the block-chain based P2P network of computers plurality.

The service delivery module (50) is configured store the details corresponding to the set of transactions for each three-party network established, tracking details and payment details in blocks of the block-chain based P2P network of computers.

Further, the three-party network is considered active. Once the network is in active state a plurality of operations may be performed such as both parties meeting in person may now be tracked for any expected movements, the secondary party may provide further details relevant to their service delivery to the second primary party during their meeting and the relevant details of the second primary party meeting may be shared with the first primary party to store on their electronic device and update the transaction history. In one embodiment, each party from the three parties may form a new three-party network at a second time interval with other one or more parties after breaking the existing three-party network between previous one or more parties. Three-party networks outlined in this embodiment will form and dis-engage after transactions for each single given network are complete. This cycle will continue, over time a large fraction of society may be a party to one or more such 3-party transactions. However, at any given instant in time we will only have 3 parties connected. Once the transaction is completed it would be saved in a block in the blockchain storage subsystem for future references and recall. The transaction details are accessed by each of the parties involved in those transactions themselves as per pre-set permission.

At the end of the desired service provision, the transactions on this network are considered as ‘complete’. Any payment to the secondary part, from the first primary party or the second primary party, may now be initiated. The payment details are also stored using block-chain transaction history module. These can be accessed later by any of the three parties. The money transfer may be managed either via a crypto-currency or established banking networks (credit/debit cards, internet banking etc.). In a specific embodiment, each party may provide each other a review of the interaction. The ‘rating’ is added to an aggregate rating, whereby future users of the network may assess each other's ratings for a better experience. It is to be understood that the present system is neither a social network model nor a service aggregator model. The application database may be updated to include these changes at this point of time. The network is now “broken”, whereby the identity details of all parties are now removed from the interface of all the three parties. Further to this, any of the three parties may form a new 3-point service network from this point onwards.

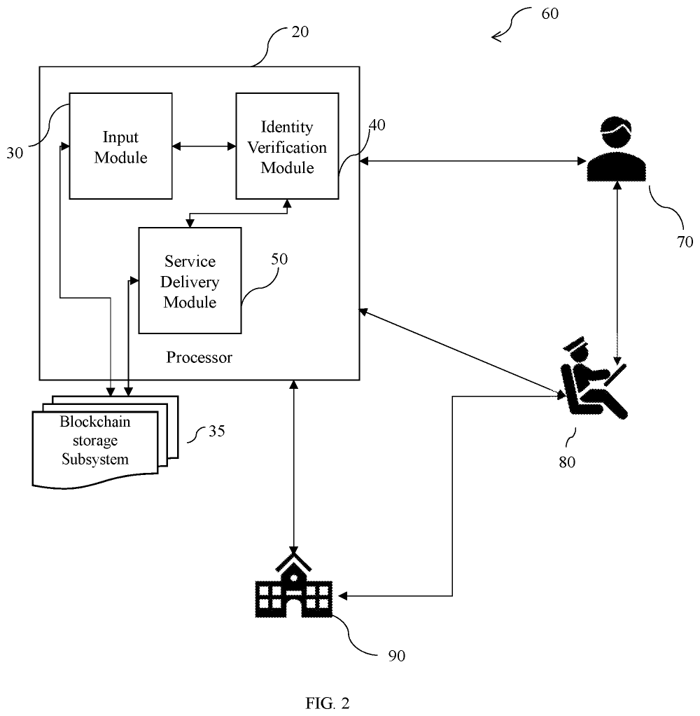

Considering an example (As shown in FIG. 2) of a pre-arranged transport service (60) to a hotel ‘H’ (90). Consider a guest ‘G’ (70) who is the second primary party arriving to a new country and has already made arrangement with a well-known chain of hotels (H) (90) which is the first primary party for the stay. The hotel H (90) sends a driver ‘D’ (80) who is a secondary party for transport from the airport to the hotel driving a car. Each party (G-D-H) in the transaction are connected to corresponding electronic devices via an interface. The input module (30) receives identities of the guest (70) and driver (80). The driver (80) may obtain the flight details on a driver device from the service delivery module (50) of the system (60), which may also notify the driver if the flight is delayed and its updated time of arrival on a guest device. Similarly, if the driver (80) is delayed due to traffic, this may be notified to the guest (70) on the guest device by the system (60). Furthermore, the location of the guest (70) and the driver (80) are used by the service delivery module (50) to suggest possible locations to the hotel (90), without prior identification for privacy reasons. When the guest (70) exits into the arrival lounge, the service delivery module (50) starts to share wireless and Bluetooth networks. It is expected that the driver (80) has local telephony and data connection whereas the guest (70) may not have it. The service delivery module (50) initiates a Hotspot sharing on Driver's handset automatically with the predetermined passwords. Such hotspot carries a range of up to 20 meters, sufficient to cover most locations with less direct obstructions. The input module (30) may also store the map of the airport on the phone to guide guest and the driver (80) before commencing air travel.

The service delivery module (50) may share their relative locations, thereby enabling the guest (70) and the driver (80) to meet in person. The guest device automatically finds and connects to the Hotspot on driver's phone. In some cases, the guest (70) and the driver (80) may speak with each other (audio/video) to speed up the identification. Moreover, in some other cases, the service delivery module (50) may generate a notification to the hotel (90) that the guest (70) has accepted to connect with the driver (70). The driver device, after acceptance from the guest (70), shows the photo and name of the guest which may further aid the guest (70) and the driver (80) to meet in person.

Network is now considered in active state (G-D-H) upon creating the geofence within the airport. Once the network is in active state, a hotel registration system gets updated with the name of the guest. Further, driver's car may now be tracked automatically to estimate their arrival. Also, the guest (70) may provide the relevant personal details such as name, tax details, card details, and the like for the hotel, so that the relevant details may be transferred to the hotel (90). Such details may be referred in person on arrival and confirmed/modified before picking up the keys.

In addition, the guest (70) may also choose to get tips about the local culture and customs, guide for personal safety, and leisure activities in the area. The guest (70) may obtain the cuisine details of the restaurant in the hotel (90), whereby the guest (70) can order food to be ready while they reach the hotel (90) using a transaction processing module. Also, the driver may offer other value-added services such as water, handtowels, Internet or the like.

At the end of the trip, the guest (70) can sign in the hotel (90), and all the transactions on this (G-D-H) network are considered as ‘complete’. Furthermore, the driver (80), the guest (70) and the hotel (90) may provide each other a review of the interaction. The transaction is timely stored in the block-chain based P2P network of computers (35) and will be accessible in future to all three parties.

Any payment to the driver (80), from the guest (70) or the hotel (90), may now be initiated. The money transfer may be managed either via a crypto-currency or established banking networks such as credit cards, debit cards, or the like. The network is now “broken”, whereby the identity details of all parties are now removed from the interface of all the three parties.

In case the guest (70) is not agreeable, the guest (70) may then “Decline” to connect with the driver (80). The hotel (90) may “Delay” the transaction and provide another driver to replace the earlier. In such case the network does not form and delayed for a time period.

The guest (70) may also be able to, under certain condition, “cancel” the transaction via the guest device. Another new party transaction may then be enabled. Any new contract between any of the parties is now be a fresh “network”. Examples of new networks are such as Hotel-Guest-Driver: the driver (80) may help the guest (70) for local transport, Hotel-Guest-Restaurant: the guest (70) may reach a restaurant, not necessarily connected with the Hotel (90), for specialty food and Hotel-Guest-Adventure Club: the hotel (90) may team with a local adventure club some leisure activities for the guest (70). The hotel (90) may offer health-related services to the guest (70), in case of any sudden ailment. The driver is enabled to cancel under certain conditions such as car failure or traffic delays. In such scenarios, a new network can form via another driver identified by the hotel.

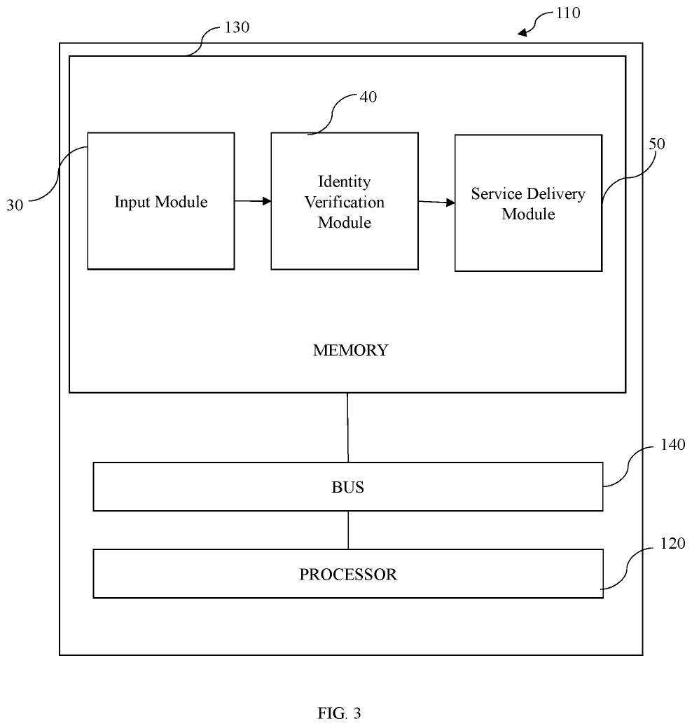

FIG. 3 is a block diagram representation of a shows an illustrative embodiment of a general computer system for use with the system of FIGS. 1 and 2. The general computer system may be a server (110) or a smart device including processor(s) (120), and memory (130) operatively coupled to the bus (140).

The processor(s) (120), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

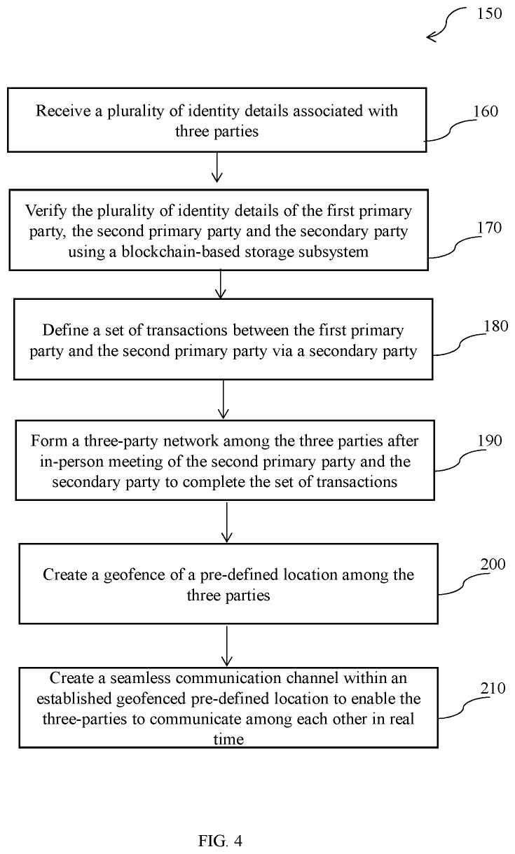

The memory (130) includes a plurality of modules stored in the form of executable program which instructs the processor (120) to perform the method steps illustrated in FIG. 4. The memory (130) is substantially similar to the system (10) of FIG. 1. The memory (130) has the following modules: an input module (30), an identity verification module (40), a service delivery module (50).

The input module (40) is configured to receive a plurality of identity details associated with three parties and the corresponding plurality of services provided delivered by the first primary party to the second primary party via secondary party. The identity verification module (50) is configured to verify the plurality of identity details of the first primary party, the second primary party and the secondary party using a block-chain based P2P network of computers. The service delivery module (50) is configured to define a set of transactions between the first primary party and the second primary party via a secondary party, wherein the set of transactions are corresponding to the plurality of services. The service delivery module (50) is configured to form a three-party network among the three parties to complete the set of transactions, prior to commencing at least one of a future transaction between the same parties.

FIG. 4 is a flow chart representing steps involved in a method (150) for creating a three-party communication platform to deliver a plurality of services in accordance with an embodiment of the present disclosure. The method (150) includes receiving a plurality of identity details associated with three parties, wherein the three parties comprises a first primary party, a second primary party and a secondary party in step 160. In one embodiment, receiving the plurality of identity details may include receiving the plurality of identity details by an input module. In one exemplary embodiment, the method (150) may further include tracking a real-time location of at least one of the first primary party, the second primary party and the secondary party tracked using a tracking enabled smart device. In such embodiment, the tracking enabled smart device may be a GPS tracking enabled smart device.

The method (150) also includes verifying the plurality of identity details of the first primary party, the second primary party and the secondary party using a block-chain based P2P network of computers in step 170. In one embodiment, verifying the plurality of identity details may include verifying the plurality of identity details by an identity verification module. In one exemplary embodiment, the method (150) may further include generating a unique identity for each of the first primary party, the second primary party and the secondary party using blockchain platform. The method (150) may further include linking the unique identity with the plurality of identity details. In such embodiment, generating the unique identity may include generating the unique identity using a code generation module.

Furthermore, the method (150) includes defining a set of transactions between the first primary party and the second primary party via a secondary party, wherein the set of transactions are corresponding to the plurality of services in step 180. In one embodiment, defining the set of transactions may include defining the set of transactions by a service delivery module.

The method (150) also includes establishing a three-party network among the three parties to complete the set of transactions, prior to commencing at least one of a future transaction between the same parties in step 190. In one embodiment, forming the three-party network includes forming the three-party network by the service delivery module. In one exemplary embodiment, the method (150) further include sharing the plurality of details corresponding to the set of transactions from the first primary party to the second primary party via the secondary party, wherein sharing the plurality of details includes creating a network of the first primary party, the second primary party and the secondary party for providing at least one of the plurality of services to each other. In one embodiment, sharing the plurality of details may include sharing plurality of details by the service delivery module.

The method (150) also includes creating a geofence of a pre-defined location among the three parties in step 200. In one embodiment, creating the geofence may include creating the geofence by the service delivery module. In one exemplary embodiment, the method (150) may further include providing one or more actions upon creating the geofence at the pre-defined location. In such embodiment, providing one or more actions may include providing one of fetching the passwords for available Wi-Fi network at the pre-defined location, attempt to connect to one or more devices using the available network at the pre-defined location, creation of Hotspot using a network, creation of a Bluetooth based network to establish a link between the electronic devices of the second primary party and the secondary party, sending an alert of arrival to the second primary party, or the combination thereof by the service delivery module.

The method (150) also includes creating a seamless communication channel within an established geofenced pre-defined location to enable the three-parties to communicate among each other in real time in step 210. In one embodiment, creating the seamless communication channel may include creating the seamless communication channel by the service delivery module. in one exemplary embodiment, creating the seamless communication channel may include creating one of the Bluetooth channel, the wireless fidelity channel, the hotspot channel or the like within the geofenced pre-defined location

Various embodiments of the system and method a three-party communication platform to deliver a plurality of services enables a simple interface as there are no complicated buttons or passwords to be used. The method provides privacy guaranteed as no placards, no publicly available lists used anywhere. The method also provides enhanced safety and reduced stress as it provides the Guest with quick and safe way to connect with the Driver, the Hotel (using Hotspot from the Driver's phone), and his/her friends and family. The system provides the local map, the map of the airport/railway station and the emergency local contacts. There is no need for internet to identify the Driver. No paper documentation is necessary till the network is complete.

Furthermore, the system provides real-time information about the Guest arrival and Driver location. The system minimizes the delay in Guest—Driver meeting and a confirmed report of the Guest-Driver meeting is obtained (for Hotel) automatically. Safety and privacy of the Guest is guaranteed. No network connectivity on part of the Guest is required. The system reduces human efforts as Guest arrival details may be provided to the Hotel electronic system automatically. Higher efficiency would follow via an improved resource management.

In addition, the method provides more safety and dignity to driver as the driver do not need to stand and wait for an indeterminate time at the airport. The system is efficient and reduce anxiety or stress of the driver as there is a method of easier identification of the guest which minimizes human errors. The application area of the method and the system includes courier pickup or delivery; services such as distribution services; personal e-retailing; house service provision: such as cleaning and repairs; and tourism-related services such as Ayurveda, medical tourism, adventure tourism and the like.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/We claim:

1. A system (10) to create a three-party communication platform to deliver a plurality of services comprising:
one or more processors (20) comprising:
an input module (30) configured to receive a plurality of identity details associated with at least three parties and the corresponding plurality of services provided delivered by the first primary party to the second primary party via secondary party, wherein the three parties comprise a first primary party, a second primary party and one or more secondary parties;
an identity verification module (40) operatively coupled to the input module (30), and configured to verify the plurality of identity details of the first primary party, the second primary party and the secondary party using a block-chain based P2P network of computers, wherein in order to verify in the blockchain-based storage subsystem, P2P networks accept public and encrypted private keys from the first primary party, the second primary party and the secondary party;
a service delivery module (50) operatively coupled to the identity verification module (40), and configured to:
define a set of transactions between the first primary party and the second primary party via a secondary party, wherein the set of transactions are corresponding to the plurality of services;
establish a three-party network among the three parties to complete the set of transactions, prior to commencing at least one of a future transaction between the same parties upon tracking a location of each of the three parties,
create a geofence at a pre-defined location via smart devices associated with one of the second primary party and the secondary party among the three parties;
create a seamless communication channel within an established geofenced pre-defined location to enable the three-parties to communicate among each other in real time based on one of a Bluetooth channel, a wireless fidelity channel or a hotspot channel within the geofenced pre-defined location;
enable payments for services rendered via one of banking network and a crypto-currency using the block-chain based P2P network of computers plurality; and
store the details corresponding to the set of transactions for each three-party network established and payment details in the block-chain based P2P network of computers.

2. The system (10) as claimed in the claim 1, wherein the one or more processors (20) comprises a location tracking module operatively coupled to the input module (30), and configured to receive a real-time location of at least one of the first primary party, the second primary party and the secondary party tracked using a tracking enabled smart device and store plurality of details corresponding to the set of transactions.

3. The system (10) as claimed in the claim 1, wherein the one or more processors (20) comprises an identity generation module operatively coupled to the input module (30), and configured to establish a unique identity for each of the first primary party, the second primary party and the secondary party using blockchain platform.

4. The system (10) as claimed in the claim 1, wherein the service delivery module (50) is configured to share the plurality of details corresponding to the set of transactions from the first primary party to the second primary party via the secondary party, wherein sharing the plurality of details includes establishing communication for the first primary party, the second primary party and the secondary party for providing at least one of the plurality of services to each other.

5. The system (10) as claimed in the claim 1, wherein the three-party network comprises a network's service set identifiers (SSIDs) for secured interaction to avoid public intervention.

6. The system (10) as claimed in the claim 1, wherein the service delivery module (50) is also configured to provide one or more actions upon creating the geofence at the pre-defined location, wherein the one or more actions comprises one of fetching the passwords for available Wi-Fi network at the pre-defined location, attempt to connect to one or more devices using the available network at the pre-defined location, creation of Hotspot using a network, creation of a Bluetooth based network to establish a link between the electronic devices of the second primary party and the secondary party, sending an alert of arrival to the second primary party, or the combination thereof.

7. The system (10) as claimed in the claim 1, wherein the system, for creating the seamless communication channel, is configured to
identify one of the Bluetooth channel, a wireless fidelity channel or a hotspot channel available within the geofenced pre-defined location; and
select one identified channel from one or more identified channel based on priority ranking.

8. A method (150) for creating a three-party communication platform to deliver a plurality of services comprising:
receiving, by an input module, a plurality of identity details associated with three parties, wherein the three parties comprises a first primary party, a second primary party and a secondary party; (160)
verifying, by an identity verification module, the plurality of identity details of the first primary party, the second primary party and the secondary party using a block-chain based P2P network of computers based on P2P networks by accept public and encrypted private keys from the first primary party, the second primary party and the secondary party and match them with value stored across a distributed network;
defining, by a service delivery module, a set of transactions between the first primary party and the second primary party via a secondary party, wherein the set of transactions are corresponding to the plurality of services; (180)
establishing, by the service delivery module, a three-party network among the three parties to complete the set of transactions, prior to commencing at least one of the future transactions between the same parties upon tracking a location of each of the three parties; (190)
creating, by the service delivery module, a geofence of a pre-defined location among the three parties; (200)
creating, by the service delivery module, a seamless communication channel within an established geofenced pre-defined location to enable the three-parties to communicate among each other in real time. (210)

9. The method (150) as claimed in claim 8, comprising tracking, by a location tracking module, a real-time location of at least one of the first primary party, the second primary party and the secondary party tracked using a tracking enabled smart device.

10. The method (150) as claimed in claim 8, comprising generation of, by a code generation module, an unique identity for each of the first primary party, the second primary party and the secondary party using blockchain platform.

11. The method (150) as claimed in claim 8, comprising storing the plurality of details corresponding to the set of transactions in the block-chain based P2P network of computer, and sharing, by the service delivery module, the plurality of details corresponding to the set of transactions from the first primary party to the second primary party via the secondary party, wherein sharing the plurality of details includes creating a network of the first primary party, the second primary party and the secondary party for providing at least one of the plurality of services to each other.
